(19) United States
(12) Patent Application Publication
(10) Pub. No.: US 2002/0186116 A1
(43) Pub. Date: Dec. 12, 2002

(54) Inductor using printed circuit board

(75) Inventor: Andy Lee, Taipei (TW)

Correspondence Address: DARBY & DARBY P.C., 805 Third Avenue, New York, NY, 10022, US

(73) Assignee: Mitac International Corp.

(21) Appl. No.: 09/875,743

(22) Filed: Jun. 6, 2001

(51) Int. Cl. H01F 27/28

(52) U.S. Cl. 336/223

(57) ABSTRACT

An inductor uses a printed circuit board rather than conventional wire coils to improve energy and time efficiency, and enhance productivity and quality control; furthermore, the present invention increases the inductance and current-endurance value by increasing the layers and coils in the conductive line.

### BACKGROUND OF THE INVENTION

1. Field of the Invention

The present invention relates to an inductor. In particular, the present invention relates to an inductor using printed circuit board to replace the conventional coil.

2. Description of the Related Art

Conventional inductor components or devices are formed primarily by coiling wire around a core. However, coiling carried out manually or by coiling machines is usually extremely energy- and time-consuming. Additionally, various coiling methods frequently cause damage to the wire. Quality inconsistencies due to damage to the protective/insulation layers of the wires during the coiling process also occurs. Insulating paint is frequently chipped off from excessive friction between the wire and the core or bobbin, as well as from repeated bending and winding in the coiling process.

### SUMMARY OF THE INVENTION

An object of the present invention is to provide a novel inductor device, comprising a core body and an exciter component. The exciter component is comprised of a printed circuit board with an opening in the circuit board to accept part of the core body. The conductive lines on the printed circuit board are wound along a specific orientation (clockwise or counterclockwise) around the opening and electrically connected through layers of boards to form the exciter coils of the inductor device.

Additionally, the layers and the number of coils on the printed circuit board is variable to meet inductance demands and desired current endurance requirements.

### BRIEF DESCRIPTION OF THE DRAWINGS

The present invention can be more fully understood by reading the subsequent detailed description in conjunction with the examples and references made to the accompanying drawings, wherein:

FIGS. 1a and 1b illustrate the inductor of the first embodiment of the present invention;

FIG. 2a shows the schematic diagram of the possible patterns of the conductive paths on the four layers of boards in FIG. 1;

FIG. 2b shows the assembly diagram of the boards; and

FIG. 3 shows a schematic diagram of a conductive-path assembly layer (Lt).

### DETAILED DESCRIPTION OF THE PREFERRED EMBODIMENT

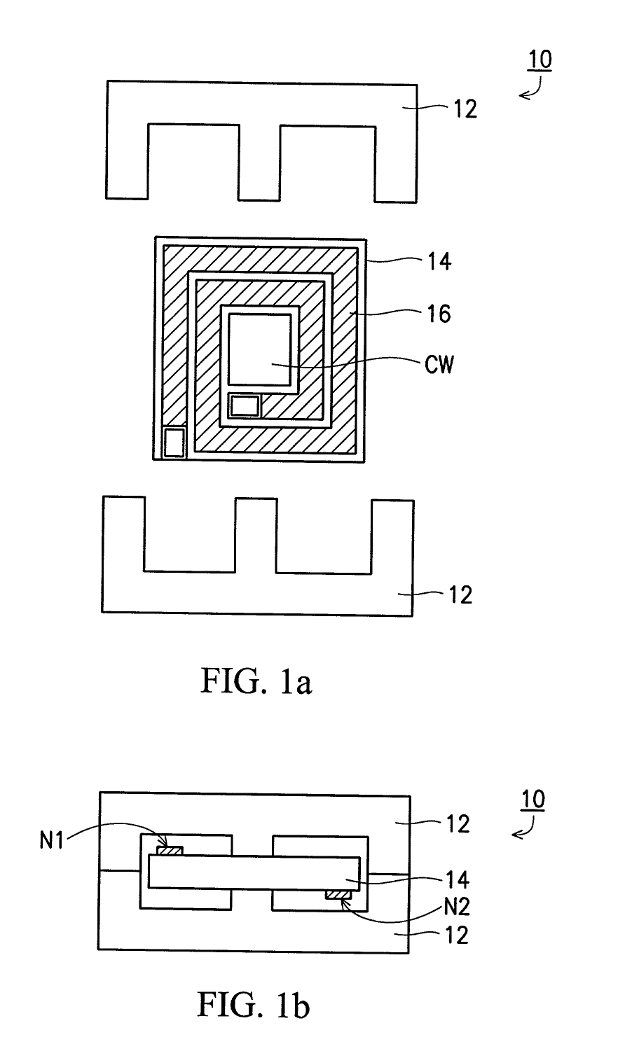

The First Embodiment FIGS. 1a and 1b illustrate the inductor of the first embodiment of the present invention. As shown in FIG. 1a, the inductor 10 of the present invention comprises: a core body 12 and a printed circuit board 14, as an exciter coil. In the embodiment, 4 layers of boards are adopted for the printed circuit board 14 as an example.

The core 12 is an EE type in this case, but it should not limit the present invention, as cores with UU, UI or other types can also be applied to the invention.

The printed circuit board 14 has an open CW through it to accept part of the core 12. A conductive line 16 on the printed circuit board 14 is wound in a clockwise orientation around the opening CW and electrically connected through the layers of boards to form the exciter coil of the inductor; wherein two nodes N1 and N2 on the inductor 10 are used for external connections.

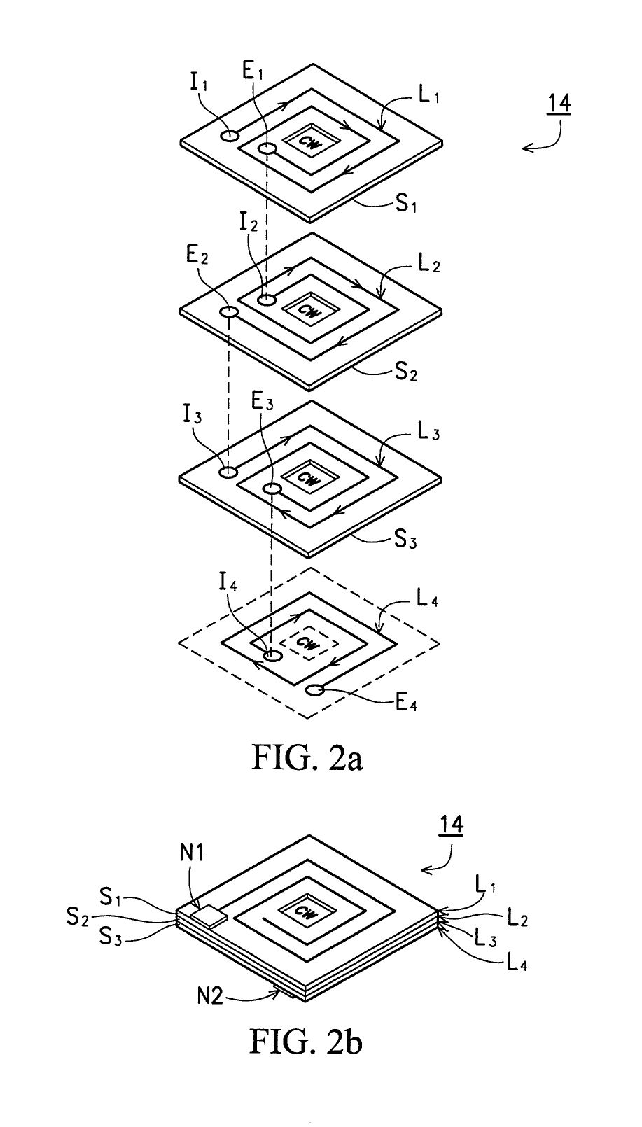

FIG. 2a shows the schematic diagram of the possible patterns of the conductive paths on the four layers of boards in FIG. 1; and FIG. 2b shows the schematic assembly diagram of the boards.

The printed circuit board 14 has 4 layers of boards including: 4 layers of conductive paths (L1˜L4); and 3 layers of insulation boards (S₁˜S₃), each respectively sandwiched between every two layers of the conductive paths.

As shown in FIG. 2a, the conductive line of the conductive path layer L1, taking I1 as the start point, winds inwardly around the opening CW in a a clockwise orientation (as the arrow sign shows in the Figure) toward an end point E1; the conductive line of the conductive path layer L2, with a start point I2 penetrating insulation board S1 to connect the end point E1 of the conductive path layer L1, winds outwardly around the opening CW in a clockwise orientation to an end point of the conductive path E2. Similarly, a conductive line of the conductive path layer L3, with a start point I3 penetrating the insulation board S2 to connect with the end point E2 of the conductive path layer L2, is wound inwardly around the opening CW in a clockwise orientation to an end point of the conductive path E3; the conductive line of the conductive path layer L4, with a start point I4 penetrating through the insulation board S3 to connect with an end point E3 of the conductive path layer L3, is wound outwardly around the opening CW in a clockwise orientation to the end point of the conductive path E4.

Thus, the conductive lines of the conductive path layers (L₁˜L₄) are connected through layers of insulation boards to form the conducting line 16 (having a start point I1 and an end point E4) wound around the core 12 in the opening CW in a clockwise orientation; and thus forming the inductor 10. Referring to FIG. 2b, the signal nodes N1 and N2 in FIG. 1b are respectively the start and end points I1 and E4 of the conductive lines of the exciter coil forming the printed circuit board 14.

The inductance of the inductor 10 can be enhanced in the present invention by increasing the number of conductive path layers simultaneously increasing the number of exciter coils in the inductor 10.

Additionally, the width of the copper path of the conductive line 16 on the printed circuit board 14 is variable to enhance the current-endurance value of the inductor 10.

The Second Embodiment

Apart from increasing the width of the copper path, the endure-current value can alternately be achieved by the following method:

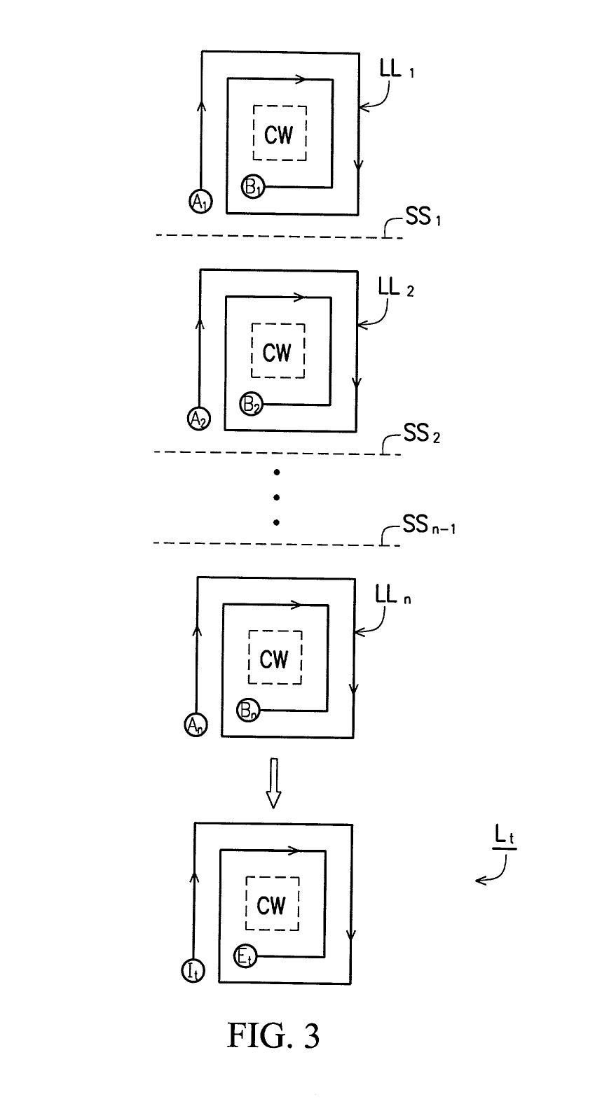

FIG. 3 shows the schematic diagram of an conductive-path assembly layer (Lₜ) comprised of n layers of conductive lines (LL₁˜LLₙ) and n−1 layers of boards (SS₁˜SSₙ₋₁). The insulation boards (SS₁˜SSₙ₋₁) are configured between each two layers of conductive lines (LL₁˜LLₙ); wherein all conductive lines (LL₁˜LLₙ) are arranged in such a manner that start points (A₁˜Aₙ) of the path lines are electrically connected through all the insulation boards (SS₁˜SSₙ₋₁). In comparison with the conductive path layers in FIG. 2a, the conductive-path assembly layer Lₜ has a current-endurance value n times that of any layer of the conductive paths L₁˜L₄.

The conductive path layers (L₁˜L₄) in the first embodiment, referring to the configuration of the conductive paths in FIG. 2a, are each assembled using the method in FIG. 3 to form an improved printed circuit board; when n=2, the printed circuit board has 8 layers of conductive lines, instead of the original layers of 4, thus the current-endurance value is doubled. So other assembly numbers of a conductive path are applicable to the present invention.

Conductive-path assemblies of 2, 4, 8 or more layers make little difference to board thickness with regard to the manufacturing process of printed circuit boards. The thickness of printed circuit board is not going to become too large when the current-endurance value is enhanced significantly.

From the illustrations described above, the printed circuit board adopts copper path lines instead of the conventional wire wraps, thereby, the number of wraps, the current-endurance value, and other properties of conventional exciter wires are equivalently defined by merely defining the configuration of the copper path lines on the printed circuit board. Therefore, the energy and time consuming problems associated with conventional wiring methodology is solved in the present invention; with the simple process of copper path configuration, quality and productivity are greatly improved. Furthermore, by increasing the layers and the rounding numbers of the conductive lines on the printed circuit, the inductance and the current-endurance value can be increased to meet requirements. It will be an extra advantage to have the printed circuit board made into SMD mode to facilitate the manufacturing and assembly process.

Finally, while the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An inductor comprises:
a core body; and an exciter component;
Wherein the exciter component comprises a printed circuit board with an opening to accept part of the core body into the opening; a conductive line on the printed circuit board winds along a specific orientation around the opening from an exciter coil of the inductor.

2. The inductor as claimed in claim 1, wherein the printed circuit board comprises: k layers of conductive paths (L₁˜Lₖ; K≧2) to become the conductive line; and k−1 layers of insulation boards (S₁˜Sₖ₋₁) respectively formed between every two conductive paths; any layer of the conductive paths is wound around the opening from a start point to an end point of the conductive path along the specific direction.

3. The inductor as claimed in claim 2, wherein the start point of conductive path layer Lₐ penetrates through the insulation board layer Sₐ₋₁ to electrically connect with the end point of the conductive path Lₐ₋₁; and the end point of the conductive path layer Lₐ penetrating through the insulation board layer Sₐ electrically connects with the end point of the conductive path Lₐ₊₁; wherein a≧2.

4. The inductor as claimed in claim 3, wherein the conductive path layer Lₐ winds outwardly away from the opening, and the conductive path layer Lₐ₊₁ winds inwardly toward the opening.

5. The inductor as claimed in claim 3, wherein the conductive path layer Lₐ winds inwardly toward the opening, and the conductive path layer Lₐ₊₁ winds outwardly away from the opening.

6. The inductor as claimed in claim 1, wherein the specific orientation is orbital around the opening with an orientation from the group consisting of clockwise and counterclockwise

7. The inductor as claimed in claim 6, wherein the conductive line, from a start point to an end point, winds inwardly along the specific direction toward the opening; and the end point of the conductive line penetrates the printed circuit board to form an electric connection with conductive path on the other side of the printed circuit board.

8. The inductor as claimed in claim 2, wherein each layer of the conductive path further comprises n layers of conductive lines and n−1 layers of insulation board sandwiched between every two layers of the conductive lines; the start points of all layers of the conductive lines pass through all of the n−1 layers of insulation board to form electric connections with each other; and the end points of all layers of the conductive lines pass through all of the n−1 layers of insulation board to form electric connections with each other as well.
